(19) United States
(12) Patent Application Publication
(10) Pub. No.: US 2004/0149121 A1
(43) Pub. Date: Aug. 5, 2004

(54) Online music release after minimum order volume logged

(75) Inventor: Clinton L. Ballard, Suquamish, WA (US)

Correspondence Address: STEVEN P KODA, KODA LAW OFFICE, 8070 E MILLPLAIN BLVD, No.141, VANCOUVER, WA, 98664, US

(73) Assignee: Acceleration Software International Corporation, Poulsbo, WA

(21) Appl. No.: 10/356,070

(22) Filed: Jan. 31, 2003

(51) Int. Cl. G10H 1/18; G10H 7/00; H04Q 1/00

(52) U.S. Cl. 84/615

(57) ABSTRACT

To purchase music online, a user becomes a member to a site which fulfils orders. An announcement is posted to members of a future release of a first song as performed by a first recording artist. Preorders are accepted from members indicating an intent to download the first song upon release for a fee. Verification is performed to determine that the member is eligible to submit the preorder. The preorders are tallied. A minimum volume of preorders is set. After the minimum volume is met, the first song is released. Members' accounts are charged the fee to access the song. By setting the minimum volume, a threshold revenue level is achieved for release of the first song assuring an established artist a minimum revenue regardless of any pirating that might occur after the release.

### BACKGROUND OF THE INVENTION

The present invention is directed to methods and apparatus for distributing media content online, and more particularly to a method and apparatus for distributing music online.

The advent of the MP3 protocol has given rise to an uncontrolled market where songs are obtained without a transaction fee. In some cases, the parties controlling the copyrights officially or unofficially authorize such distribution. In other cases, the distribution amounts to illegal pirating of copyright-protected music.

U.S. Pat. No. 6,385,596 issued May 2, 2002 to Wiser et al., discloses a secure online music distribution system in which a media player provides for encryption of user personal information, and for decryption and playback of purchased media data. Security of purchased media data is implemented in part by the use of a personal, digital passport in each media player. The digital passport contains identifying information that identifies the purchaser, along with confidential information, such as credit card number, and encryption data, such as the media player's public and private keys. The media player encryption data is used to encrypt purchased media data, which is decrypted in real time by the media player. The media player also displays confidential information, such as the purchaser's credit card number, during playback.

U.S. Pat. No. 6,469,239 issued Oct. 22, 2002 to Fukuda and assigned to Sony Corporation discloses a sound quality deteriorating process. When a copy of music data recorded in an HDD to another electronic equipment is instructed, an accounting process is performed or a sound quality deteriorating process is performed based on a selection. When the accounting process is performed, after a predetermined accounting procedure is performed, a data copying process is performed and the data is outputted to a copy destination. When the accounting process is performed, a quality of the data is held to be almost identical to that of the original data. When the sound quality deteriorating process is selected, a data conversion is performed by a predetermined sound quality deteriorating process, the quality of the data is deteriorated, and the deteriorated data is outputted to the copy destination. In this case, the accounting is not performed. Where the data is moved, the accounting process and the sound quality deteriorating process are not performed.

U.S. Pat. No. 6,073,124 issued on Jun. 6, 2000 to Krishnan et al. discloses a system for securely incorporating electronic information into an online purchasing application. A secure digital commerce system (DCS) is arranged according to a client/server architecture and includes a modularized DCS client and DCS server. The DCS client and the DCS server are incorporated into an online purchasing system, such as a virtual store, to perform the purchase and online delivery of electronic content. The DCS client includes a set of components which include a secured copy of the merchandise and various components needed to license and purchase the merchandise and to unsecure and process (e.g., execute) the licensed merchandise. The DCS client communicates with the DCS server to download the components onto a customer's computer system and to license and purchase a requested item of merchandise. The DCS server, which includes a content supplier server, a licensing and purchasing broker, and a payment processing function, supplies merchandise-specific components and licenses the requested item of merchandise by generating an electronic certificate. The electronic certificate contains license parameters that are specific to the requested merchandise and an indicated purchasing option. Once a valid electronic license certificate for the requested merchandise is received by the DCS client, the merchandise is made available to the customer for use in accordance with the licensing parameters contained in the electronic license certificate.

U.S. Pat. No. 6,236,971 issued May 22, 2001 to Stefik, et al. discloses a system for controlling the distribution and use of digital works using digital tickets. A “digital ticket” is used to entitle the ticket holder to exercise some usage right with respect to a digital work. Usage rights are used to define how a digital work may be used or distributed. Each usage right may specify a digital ticket which must be present before the right may be exercised. Digital works are stored in repositories which enforce a digital works usage rights. Each repository has a “generic ticket agent” which punches tickets. In some instances only the generic ticket agent is necessary. In other instances, punching by a “special ticket agent” residing on another repository may be needed.

### SUMMARY OF INVENTION

To purchase music online, a user becomes a member at an online site which takes orders. An announcement is posted and accessible to members indicating a future release of a specific song as performed by a specific recording artist. Preorders are accepted from members indicating an intent to purchase a copy of the song upon release through the membership. Verification is performed to determine that the member is eligible to submit the preorder. The preorders received from all members are tallied over time to track the number of copies of the song that have been preordered. A minimum preorder volume (number of copies) is set for the song. After the minimum volume is met, the corresponding song is released. Members' accounts are charged the fee to access the song, (e.g., download the song, receive a copy of the song). By setting the minimum volume, a threshold revenue level is achieved for release of the song assuring an artist a minimum revenue regardless of any pirating that might occur after the release. The system also is implemented for distributing other information, such as electronic books, movies, and multimedia content.

### BRIEF DESCRIPTION OF THE DRAWINGS

FIG. 1 is a schematic diagram of a global computer network;

FIG. 2 is a block diagram of a computer system for a computer connected into the global computer network of FIG. 1;

FIG. 3 is a diagram of an end user computer linked to a server computer which is linked to the global computer network;

FIG. 4 is a block diagram of a global network computer computing environment;

FIG. 5 is a diagram of a method for distributing music online;

FIG. 6 is a flow chart of a preordering process for the method of FIG. 5;

FIG. 7 is a flow chart of a release decision process for the method of FIG. 5;

FIG. 8 is a flow chart of a release process for the method of FIG. 5;

FIG. 9 is a diagram of a database of works subject to the distribution method of FIG. 5;

FIG. 10 is a diagram of preorder tables used for synchronizing client preorder information with a web site preorder information; and

FIG. 11 is a flow chart of a process for fulfilling preorders.

### DESCRIPTION OF SPECIFIC EMBODIMENTS

Host Network Environment

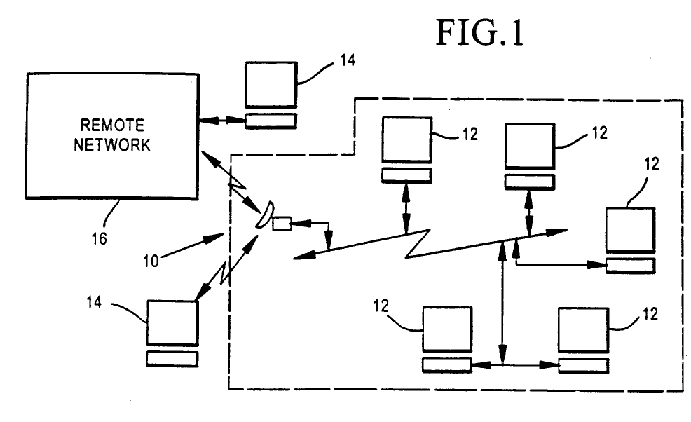

FIG. 1 shows a global computer network 10 formed by a plurality of network server computers 12 which are interlinked. Each network server computer 12 stores files accessible to other network server computers 12 and to client computers 14 and networks 16 which link into the global computer network 10. The configuration of the network 10 may change over time as client computers 14 and one or more networks 16 connect and disconnect from the network 10. For example, when a client computer 14 and a network 16 are connected with the network server computers 12, the global computer network includes such client computer 14 and network 16. As used herein the term computer includes any device or machine capable of accepting data, applying prescribed processes to the data, and supplying results of the processes.

The global computer network 10 stores information which is accessible to the network server computers 12, remote networks 16 and client computers 14. The information is accessible as files. The term file as used herein, includes files (as per the Windows operating system usage), documents (as per the MacOS operating system usage), pages (as per the world wide web phraseology usage), and other records, entries or terminology used to describe a unit of a data base, a unit of a file system or a unit of another data or information resource. Typically, there are text files, binary files, audio files, video files, multimedia files, and other types of data files and executable files stored on the global computer network.

A client computer 14 accesses the global computer network 10 by a wired or a wireless transfer medium. A user accesses the internet, for example, using a modem and either a telephone communication network, cable communication network or satellite communication network.

The network server computers 12 are formed by main frame computers minicomputers, and/or microcomputers having one or more processors each. The server computers 12 are linked together by wired and/or wireless transfer media, such as conductive wire, fiber optic cable, and/or microwave transmission media, satellite transmission media or other conductive, optic or electromagnetic wave transmission media. The client computers 14 access a network server computer 12 by a similar wired or a wireless transfer medium. In one embodiment the global computer network is embodied by the Internet and its World Wide Web (WWW).

The client computer 14 is any end user computer, and may also be a mainframe computer, minicomputer or microcomputer having one or more microprocessors. The remote network 16 may be a local area network, a network added into the global computer network through an independent service provider (ISP) for the internet, or another group of computers interconnected by wired or wireless transfer media having a configuration which is either fixed or changing over time. Client computers 14 may link into and access the global computer network 10 independently or through a remote network 16.

Computer System

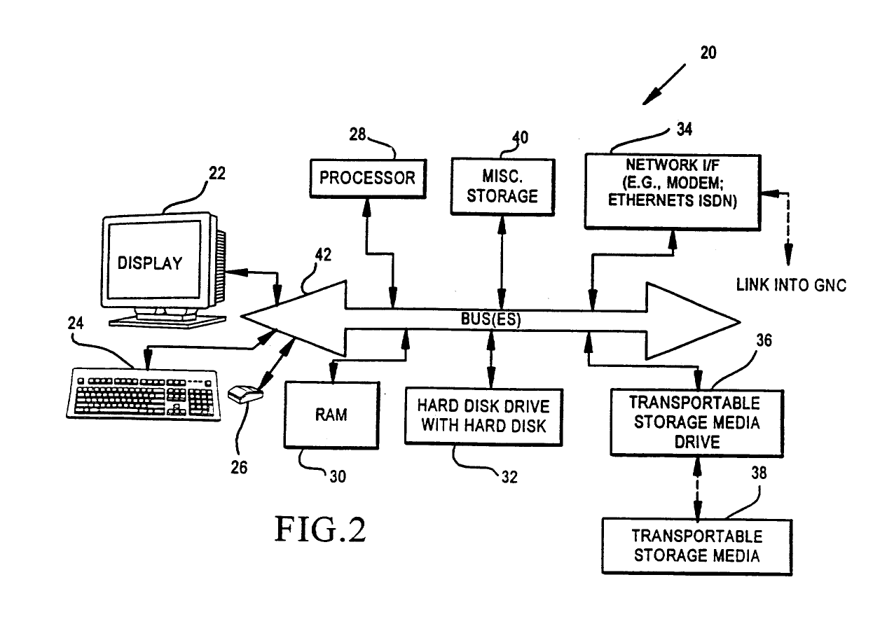

The functions of the present invention preferably are performed by programmed digital computers of the type well known in the art, an example of which is shown in FIG. 2. A computer system 20 has a display 22, a key entry device 24, a pointing/clicking device 26, a processor 28, random access memory (RAM) 30,and a communication or network interface 34 (e.g., modem; ethernet adapter). In addition, there commonly is a non-volatile storage device such as a hard disk drive 32 and a transportable storage media drive 36 which reads transportable storage media 38. Other miscellaneous storage devices 40, such as a floppy disk drive, CD-ROM drive, DVD drive, CD-RW drive, zip drive, bernoulli drive or other magnetic, optical or other storage media, may be included. The various components interface and exchange data and commands through one or more busses 42. The computer system 20 receives information by entry through the key entry device 24, pointing/clicking device 26, the network interface 34 or another input device or input port. The computer system 20 may be any of the types well known in the art, such as a mainframe computer, minicomputer, or microcomputer and may serve as a network server computer 12, remote network 16 computer or a client computer 14. The computer system 20 may even be configured as a workstation, personal computer, network server, or a reduced-feature network terminal device.

Accessing the WWW

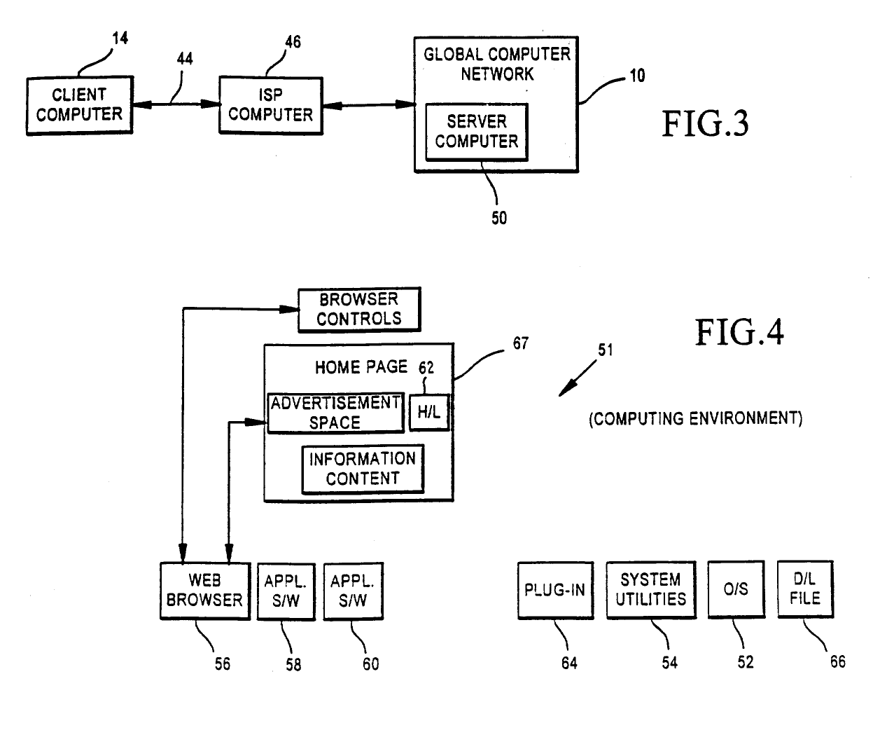

Referring to FIG. 3, a client computer 14 accesses the global computer network 10 such as the Internet through a service provider computer 46 (such as an Internet Service Provider—‘ISP’). In some embodiments, the client computer is directly linked into the network 10. When accessing the WWW portion of the global computer network 10, the client computer 14 accesses information using a uniform resource locator (‘URL’) address. Information from the URL is retrieved and displayed at the computer 14 display 22—such displayed information typically is referred to as a web page. Web browser software controls the communication of URL addresses and the formatting of retrieved information.

Once the user is logged onto the global computer network 10 and the home page is displayed, the user can browse other web pages. Typically, the home page 67 has a set of hyperlinks (H/L) 62 (see FIG. 4) which are preprogrammed with URL addresses for other information resources. In addition, there is a command line which allows a user to type in any URL. Typically the web browser tracks the various web pages visited in a session and allows the user to go back or forward within such list. Often the web browser allows the user to store a list of favorite web pages visited.

Another common way of browsing resources is to access a search engine at a server computer 50. Once the user accesses the web page which serves as a search engine, the user enters search criteria (e.g., keywords, URL). The search engine then retrieves a list of hyperlinks to web pages meeting the search criteria. There are several known search engines that search for WWW documents. These are accessed by URL identifier, and include, for example, Yahoo, Magellan, Lycos, Altavista, Looksmart, and YourPortal. There also are search engines that search for audio songs, such as the MP3 based search engines.

Referring to FIG. 4, a computing environment 51 is displayed. The computing environment 51 is formed by the software programs being executed by the client computer 14. Included are an operating system 52 (e.g., Apple's MacOS platform; any of Microsoft's DOS or Windows platforms; any of the permutations of the UNIX operating system; Linux or others). Also included are one or more system utilities 54 which control the operation of the computer 14 and the interaction with peripheral devices. In addition, there are one or more application programs 56-60 which greatly influence the working or playing environment for the user (e.g., games, word processors, spreadsheets, presentation graphics, accounting programs).

With the proliferation of the global computer network a common application program is a web browser program 56. The web browser (e.g., Netscape Navigator; Microsoft Internet Explorer; MOSAIC; or others) controls access to the global computer network 10. To supplement the functionality of the web browser 56 and allow more effective access to the global communication network's information resources, there typically are several additional software programs called by the web browser software 56. These programs are referred to as software plug-ins 64, because they are initiated by the web browser 56 or are initiated in relation to web browser operation or global computer network access. In addition, there may be one or more self-executing files 66 (e.g., JAVA programs or other programs or scripts) downloaded from the global computer network 10.

Method for Distributing Information Content

Information content (i.e., a work of authorship) is offered for purchase online through a web site. The web site owner procures the right to offer the information content for distribution. For example, the web site owner negotiates with rightholders of the information content, such as a music composer, book author, production company, recording company, book publisher, movie studio or the like. In one example, the right to offer artist songs is procured from the artist on a ‘cost+fee’ basis. The artist receives proceeds from the distribution of their song less costs of distribution and an agreed upon fee. Although the term purchase is used herein, the term is used as in the respective industry where the end user purchases a limited right to view, listen or display the work for their personal use.

The web site is a portal into an online distribution system implemented with computer software. Promotion of the work is done according to the rightholder's business strategy. The rightholder may promote the work over the radio, the television, and the internet. In some embodiments a sample portion of the work is viewed, listened to or displayed by accessing a hyperlink of the web site, or otherwise entering an appropriate command or request.

Works of authorship which have been released for distribution are available for downloading from the web site. In addition, preorders of works not yet released are accepted at the web site.

Referring to FIG. 5 a flow chart of the distribution process 70 is shown for a work in which the right to offer the work has been procured. The distribution process is implemented in software with client input for browsing offerings and making purchases and management software for maintaining a data base of offerings and implementing distribution decisions. At step 72 a process for maintaining records associated with a work is implemented. For example, a master data base of works is maintained. Records are added, deleted and maintained. When rights to a new work are procured, a record is created and added to the data base. When a work is withdrawn, the record is updated to reflect that is no longer available. Eventually the record is deleted. When the status of a work changes, the record is updated to reflect the current status.

In one embodiment a notice is posted at the web site that preorders are being taken for a specific work of authorship that has not yet been released. Such notice includes in one embodiment a displayed record among a listing of many records, in which each record corresponds to a work of authorship. The record indicates whether the work is offered at this time for preorder or for download. For, example, after the work is released, the work is thereafter available for download rather than for preorder. Alternatively or in addition the notice is sent via e-mail to a distribution list.

Referring to FIGS. 5 and 6, at step 74 preorder processing is performed in response to a preorder received at step 75 from a client computer over the internet. The preorder processing includes identifying (step 76) the work which is the subject of the preorder and logging (step 78) the preorder. In some embodiments, preorder processing also includes a verification step 80. The verification step includes any one or more of the following: identifying the user as a member in good standing, verifying credit through a specified payment mechanism, or verifying a balance in a debit account of funds for use in making online purchases. The source of funds is either communicated with the preorder or is on file for the client end user, (e.g., member).

Logging of the preorder includes tallying the total number of copies of a work that have been preordered through the web site at which the online offering is made. In some embodiments, the client information also is recorded for future fulfillment of the preorder.

Referring to FIGS. 5 and 7, at step 82 a release decision-making process is performed. The decision to release the work of authorship for distribution is made based upon a select criteria. In one embodiment the criteria is merely a date of release. When the date arrives, the work is released. In a preferred embodiment, the decision to release is based upon the quantity of copies preordered. At step 83 the threshold number is identified. At step 85 the threshold number is compared to the tallied number of preorders. When a threshold quantity is achieved, the work is thereafter released. In some embodiments, the threshold quantity is made in advance for a given work as agreed to by the web site owner and the rightholder.

Alternatively, a party with authority to make the decision indicates that the song is now available for release. For example, a rightholder may distribute the song through many online distributors and conventional distributors using various distribution methods. In such case the rightholder has access to marketing information relating to the expected volume to occur at the time of release. They may have a threshold number of preorders in hand or they may have some other formula to use. In any event, the decision maker informs the web site owner of the criteria for release, (e.g., release now, release upon receiving a set number of preorders, release on a set date). Thus, at some time a decision to release the work is made or the offer to release the work is withdrawn.

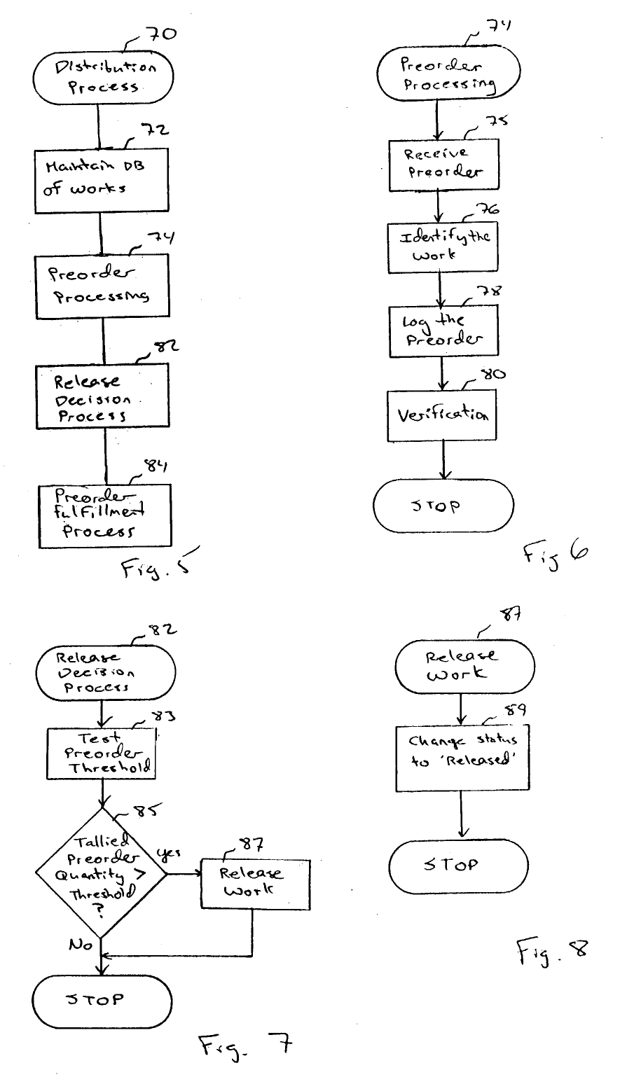

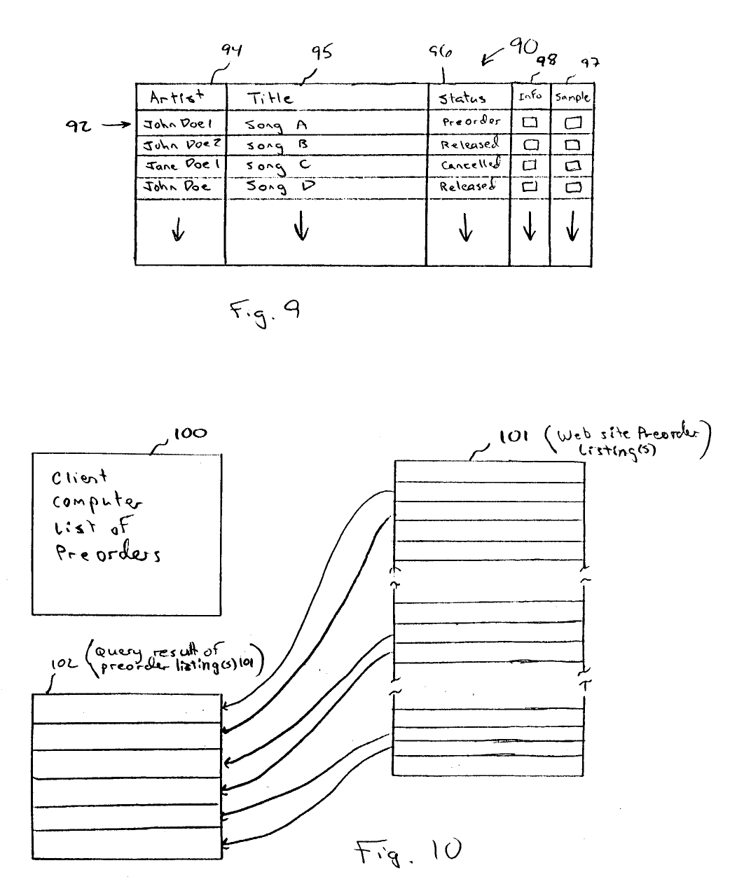

Referring to FIGS. 7 and 8, at step 87 the work of authorship is released for distribution through the online distributor's web site. In one embodiment the record for the work in a listing of works posted at the web site changes status at step 89 from one indicating that preorders are being taken to one indicating that the work is available for download. In some embodiments additional steps also are taken. For example, in one embodiment a notice is sent to all who submitted preorders that the work is available for downloading. In another embodiment the work is sent via e-mail to the client who submitted the preorder. For an embodiment in which the client pays a sum of money at the time of making the preorder, the notice includes a security code allowing access for a one-time download of the work. For an embodiment in which the client does not pay in advance, payment is made at the time the client downloads the work. Accordingly, in differing embodiments, either hard preorders are taken (in which payment has been made in advance) or soft preorders are taken (in which an agreement to download the work for a set fee upon release is made).

In various embodiments the released work available for download is a pure digital copy of high quality which is not encrypted. In other embodiments, the released work is of reduced quality. In still other embodiments the released copy is encrypted. In the case where encryption is implemented a decrypting scheme also is implemented to give the purchaser the ability to view, listen to or display the work.

According to a preferred embodiment, the copy is not encrypted and is of the same or reduced quality as the original recording of the work. By waiting for a threshold number of preorders to be received, the rightholder is assured a minimum revenue. By strategically selecting the threshold number of preorders a viable market opportunity is achieved. Accordingly, even if pirating occurs after the release, the rightholder achieves a threshold level of revenue. Such a model is viable for many independent artists. Further as an artist develops their following, they can achieve higher revenues by setting a higher threshold level of preorders prior to release.

In effect the artist trades off developing the market for one song over time with developing a market for their future songs. Consider this example. A song unexpectedly takes off after being released. A portion of that post release volume is going to be legitimate. Another portion of the volume is going to be unaccounted illegal pirating: The artist has been assured some threshold level of revenue based upon their selection of the threshold preorder quantity. However, they have lost out on some revenues due to the illegal pirating. Such pirating in effect becomes a form of promotion. The artist is developing name recognition and a following. The pirating becomes part of the business model for doing business over the internet. As name recognition develops, the artist can dictate a higher threshold number of preorders to be made prior to the release of future works.

Referring to FIG. 9, table 90 is a listing of works offered online through a web site. The table includes a plurality of records 92. Each record contains a number of fields. For example, for a table of musical works, there is a an artist field 94 which identifies the artist performing the work, a title field 95 identifying the title of the work, a status field 96 indicating the release status of the work (e.g., accepting pre-orders, released and available for download, canceled) In addition in some embodiments there is a ‘button’ or hyperlink 97 which upon activation plays a sample of the work and/or a ‘button’ hyperlink 98 which upon activation displays a description of the work (e.g., a marketing blurb, credits, contact information). Similar tables are implemented for other types of works. For a movie there is a field for the studio rather than the artist.

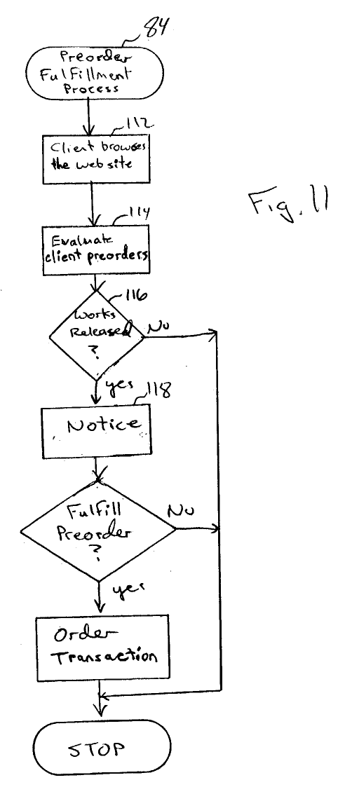

Referring to FIG. 10, a client computer maintains a list 100 of preorders which have been submitted to the web site for various works of authorship. The online distributor also maintains one or more listings 101 of preorders. For example, a master listing of preorders is maintained for all works. Alternatively, a listing is maintained for each work. In one embodiment, when a client submits a preorder, a preorder synchronization process also is performed. The new preorder is entered. In addition, the preorders in the list 100 are compared to the preorder records in the listings 101 of the online distributor. For example the online distribution software generates a query of preorders associated with the client. The listings 101 are queried for the client preorders. The result is a query result listing 102 of preorders associated with the specific client. The client list 100 and the query result list 102 are compared. Where there is a discrepancy, a correction process is implemented. In one embodiment the correction process communicates the discrepancy to the client. For example, the discrepancy may be that the client list includes preorders not logged at the web site. The client can then confirm any one or more of the preorders and have them entered and logged. Alternatively, the client can refuse any one or more of the preorders and have them deleted from his list 100. As another example, the discrepancy may be that the client list 100 lacks preorders attributed to the client at the master listings 101. The discrepancy is displayed to the client who can then confirm that any one or more of such preorders are NOT desired. In such case, the selected preorders are removed from the master listings 101 and the tally for each work is corrected. Alternatively, the client can indicate a desire for any one or more of the preorders and have the record included in his lift 100.

FIG. 11 is a flow chart of a preorder fulfillment process 84 according to one embodiment. At step 112 a client browses the online offerings at an associated web site, triggering a check at step 114 to evaluate the client list 100 and determine at step 116 whether any works on the list 100 have been released. If no works on the list 100 have been released, then preorder fulfillment does not occur at that time. If one or more works on the list 100 have been released, then at step 118 the client is given notice of each preordered work that has been released. At step 120, the client decides whether to fulfill any one or more of the preorders at this time. If no, then the preorders are not fulfilled. If yes, then for each preorder that the client indicates is to be to fulfilled at that time, a transaction occurs at step 122 to fulfill the order(s).

In one embodiment, the preorders have been prepaid. In such embodiment the transaction process is to download the work to the client. In addition, accounting is performed to indicate that the preorder has been fulfilled. Accordingly, the list 100 and listing 101 are updated. For example, the preorder then is deleted from the list 100. In another embodiment, the preorder is not prepaid. In such embodiment, payment is made and the download occurs. The accounting then is performed to indicate that the preorder has been fulfilled, updating the list 100 and listing 101.

Each of the client decisions are communicated by commands input through a web site portal to online distribution software. Also, the management of the online offerings also are implemented in software based on operator inputs of new listings and operator selection of the threshold volume. The release decisions is made automatically in software and made be made manually based upon operator input. By operator it is meant the online distributor's server computer operator.

Many modifications and variations of the present invention are possible in light of the above teachings. For example, although the process has been described in the context of procured rights, the concepts of the inventions may also be applied for public domain works and unauthorized distribution of authored works. Thus, it is to be understood that, within the scope of the appended claims, the invention may be practiced otherwise than as described hereinabove.

What is claimed is:

1. A method for distributing music over a global information network, comprising:
posting an announcement of a future release of a first song as performed by a first recording artist;
accepting preorders for the first song;
tallying the preorders; and
after the tallied preorders for the first song exceeds a minimum order volume, releasing the first song.

2. The method of claim 1, wherein the releasing comprises making the first song available for download.

3. The method of claim 1, wherein the releasing comprises sending an electronic copy of the first song by e-mail to fulfill the accepted preorders.

4. The method of claim 1, wherein a fee is charged for an electronic copy of the song, and wherein the minimum order volume assures a threshold revenue for the first song.

5. A method for distributing music over a global information network, comprising:
accepting members;
posting an announcement to members of a future release of a first song as performed by a first recording artist;
accepting a preorder from members indicating an intent to download the first song upon release for a fee;
verifying that the member is eligible to submit the preorder;
tallying the preorders;
setting a minimum volume of preorders;
after the minimum volume is met, releasing the first song as being available to members for download; and
charging said fee to the account of each member that downloads the first song.

6. The method of claim 5, further comprising:
enabling members to sample a portion of the first song, wherein each member has an account.

7. The method of claim 5, wherein the charging is performed prior to the member downloading the first song.

8. The method of claim 5, wherein the account is a credit card account.

9. The method of claim 5, wherein the account is a site access privilege account.

10. The method of claim 5, wherein the account is a prepaid balance.

11. The method of claim 5, wherein said verifying comprises checking the account for sufficient funds to pay the fee for the first song.

12. The method of claim 5, wherein the fee is for a one time right to download the first song.

13. The method of claim 5, further comprising:
maintaining a list of preorders for each member at a server computer;
maintaining a list of preorders on a client computer; and
synchronizing the content of the server computer list of preorders for a given member and the list of preorders on the client computer of a given member.

14. The method of claim 13, wherein said synchronizing comprises, for a given member:
adding any preorders on the client computer to the corresponding list of preorders on the server computer that are not already on said corresponding list of preorders at the server computer.

15. The method of claim 13, wherein said synchronizing comprises, for a given member:
performing a logical ‘OR’ operation between the list of preorders on the client computer and to the corresponding list of preorders on the server computer to generate an updated list of preorders for both the client computer and the sever computer.

16. The method of claim 15, wherein the member accepts the updated list prior to updating the list of preorders at the client computer and the corresponding list at the server computer.

17. A method for distributing information over a global information network, comprising:
posting an announcement of a future release of a first information media;
accepting preorders for the first information media;
tallying the preorders; and
after the tallied preorders exceeds a minimum order volume, releasing the first information media;
wherein the first information media is among the group of information media, comprising: audio media, video media, multimedia, textual media, music, movies, and books.

18. A system for distributing music over a global information network, comprising a processor and memory, wherein the processor executes computer program instructions comprising:
means for accepting members;
means for posting an announcement to members of a future release of a first song as performed by a first recording artist;
means for accepting a preorder from members indicating an intent to download the first song upon release for a fee;
means for verifying that the member is eligible to submit the preorder;
means for tallying the preorders;
means for setting a minimum volume of preorders;
means for releasing, after the minimum volume is met, the first song as being available to members for download; and
means for charging said fee to the account of each member that downloads the first song;
and wherein the memory stores data pertaining to the first song.
